(19) United States
(12) Patent Application Publication
(10) Pub. No.: US 2017/0201678 A1
(43) Pub. Date: Jul. 13, 2017

(54) USER PROMPTING METHOD, ELECTRONIC DEVICE AND COMPUTER STORAGE MEDIUM

(71) Applicant: ZTE CORPORATION, Shenzhen, Guangdong (CN)

(72) Inventor: Cheng LV, Shenzhen (CN)

(21) Appl. No.: 15/326,269

(22) PCT Filed: Aug. 12, 2014
(86) PCT No.: PCT/CN2014/084162

§ 371 Date: Feb. 22, 2017

(30) Foreign Application Priority Data
Jul. 15, 2014 (CN) 201410334508.5

(51) Int. Cl. H04N 5/232; G01C 1/00

(52) U.S. Cl. CPC H04N 5/23222; G01C 1/00; H04N 5/23293

(57) ABSTRACT

A user prompting method and an electronic device are described; the method is applied to the electronic device, and includes that: (S101) a solar azimuth angle at a current time and an optical axis direction angle of a lens disposed on the electronic device are acquired, wherein the optical axis direction angle and the solar azimuth angle have a same reference direction; (S102) a current shooting angle is acquired based on the solar azimuth angle and the optical axis direction angle; and (S103) an angle to be adjusted is determined based on the shooting angle, and a user is prompted to perform angle adjustment based on the angle to be adjusted.

### TECHNICAL FIELD

The present disclosure relates to the field of digital photography, and more particularly, to a user prompting method, an electronic device, and a computer storage medium.

### BACKGROUND

In order to satisfy demands of users for photographing, in addition to a professional photographic device such as a single-lens reflex camera and a digital camera, other devices such as a smartphone, a tablet computer, a superbook or a multimedia player are provided with an image capturing device for photographing. In this way, users can take pictures anywhere anytime.

At present, when using the above electronic devices to take pictures, most of users select an appropriate shooting angle according to a naked eye or a personal experience, in order to acquire a more ideal photo effect. However, due to differences in the personal experience, users often cannot acquire the ideal photos. At this time, users need to adjust the shooting angle to acquire the most ideal photo effect. However, during the adjusting, users need to adjust while trying to shoot, and then determine the best shooting angle according to the photos they try to shoot. In this way, the shooting process is time-consuming, and since the entire adjustment process is carried out manually by users, there is a technical problem in the related art that shooting efficiency is low.

### SUMMARY

For solving an existing technical problem, an embodiment of the present disclosure provides a user prompting method, an electronic device, and a computer storage medium, so that shooting efficiency is improved, it is convenient for users to operate, and user experience is improved.

The technical solutions of embodiments of the present disclosure are implemented as follows.

In a first aspect, an embodiment of the present disclosure provides a user prompting method applied to an electronic device, wherein the method includes that:

a solar azimuth angle at a current time and an optical axis direction angle of a lens disposed on the electronic device are acquired, wherein the optical axis direction angle and the solar azimuth angle have a same reference direction; a current shooting angle is acquired based on the solar azimuth angle and the optical axis direction angle; and an angle to be adjusted is determined based on the current shooting angle, and a user is prompted to perform angle adjustment based on the angle to be adjusted.

In the above solution, the step of acquiring a solar azimuth angle at a current time may include that: a latitude of a position where the electronic device is located currently, a solar declination angle at the current time and a solar elevation angle at the current time are acquired; and the solar azimuth angle is acquired based on the latitude, the solar declination angle, and the solar elevation angle.

In the above solution, the step of acquiring an optical axis direction angle of a lens disposed on the electronic device may include that: an orientation of the lens is acquired; and an included angle between the orientation and the reference direction is determined as the optical axis direction angle.

In the above solution, the step of determining an angle to be adjusted based on the current shooting angle may include that: a corresponding preset threshold is determined when the current shooting angle satisfies a preset condition; and a difference between the current shooting angle and the preset threshold is determined as the angle to be adjusted.

In the above solution, before determining a corresponding preset threshold when the current shooting angle satisfies a preset condition, the method may further include that: a type of a shooting subject is determined, and the preset condition is determined according to the type.

In a second aspect, an embodiment of the present disclosure provides an electronic device, wherein the electronic device includes that:

a first acquiring unit configured to acquire a solar azimuth angle at a current time and an optical axis direction angle of a lens disposed on the electronic device, wherein the optical axis direction angle and the solar azimuth angle have a same reference direction;

a second acquiring unit configured to acquire a current shooting angle based on the solar azimuth angle and the optical axis direction angle;

a first determining unit configured to determine an angle to be adjusted based on the current shooting angle; and

a prompting unit configured to prompt a user to perform angle adjustment based on the angle to be adjusted.

In the above solution, the first acquiring unit may be configured to acquire a latitude of a position where the electronic device is located currently, a solar declination angle at the current time and a solar elevation angle at the current time; and acquire the solar azimuth angle based on the latitude, the solar declination angle, and the solar elevation angle.

In the above solution, the first acquiring unit may be configured to acquire an orientation of the lens; and determine an included angle between the orientation and the reference direction as the optical axis direction angle.

In the above solution, the first determining unit may be configured to determine a corresponding preset threshold when the current shooting angle satisfies a preset condition; and determine a difference between the current shooting angle and the preset threshold as the angle to be adjusted.

In the above solution, the electronic device may further include: a second determining unit configured to, before determining a corresponding preset threshold when the second acquiring unit determines that the current shooting angle satisfies a preset condition, determine a type of a shooting subject, and determine the preset condition according to the type.

In a third aspect, an embodiment of the present disclosure provides a computer storage medium, in which a computer-executable instruction is stored, the computer-executable instruction being configured to execute the abovementioned method.

Embodiments of the present disclosure provide a user prompting method, an electronic device, and a computer storage medium. The method includes that: first, a solar azimuth angle at a current time and an optical axis direction angle of a lens disposed on the electronic device are acquired, wherein the optical axis direction angle and the solar azimuth angle have a same reference direction; then, a current shooting angle is acquired based on the solar azimuth angle and the optical axis direction angle; and next, an angle to be adjusted is determined based on the shooting angle, and a user is prompted to perform angle adjustment to the angle to be adjusted. In other words, the electronic device can automatically acquire the current shooting angle and determine the angle to be adjusted, so the user can get a better shooting effect only by adjusting to the angle to be adjusted according to the prompt, without having to try again and again. In such way, the technical problem in the related art that shooting efficiency is low is effectively solved, the shooting efficiency is improved, it is convenient for users to operate, and user experience is improved.

### BRIEF DESCRIPTION OF THE DRAWINGS

FIG. 1 is a flow chart of a user prompting method according to an embodiment of the present disclosure;

FIG. 2 is a schematic diagram of a solar azimuth angle according to an embodiment of the present disclosure;

FIG. 3 is a schematic diagram of an optical axis direction angle according to an embodiment of the present disclosure;

FIG. 4 is a schematic diagram of a current shooting angle according to an embodiment of the present disclosure;

FIG. 5 is a flow chart of a user prompting method in a backlight scenario according to an embodiment of the present disclosure; and

FIG. 6 is a structure schematic diagram of an electronic device according to an embodiment of the present disclosure.

### DETAILED DESCRIPTION

The technical solutions in embodiments of the present disclosure will be described clearly and completely hereinafter with reference to the accompanying drawings in embodiments of the present disclosure.

An embodiment of the present disclosure provides a user prompting method applied to an electronic device such as a smartphone, a tablet computer, a single-lens reflex camera, a digital camera, and a multimedia player. These electronic devices are provided with devices such as a Global Positioning System (GPS) module, a gyroscope, and an electronic compass, in addition to an image capturing device for photographing.

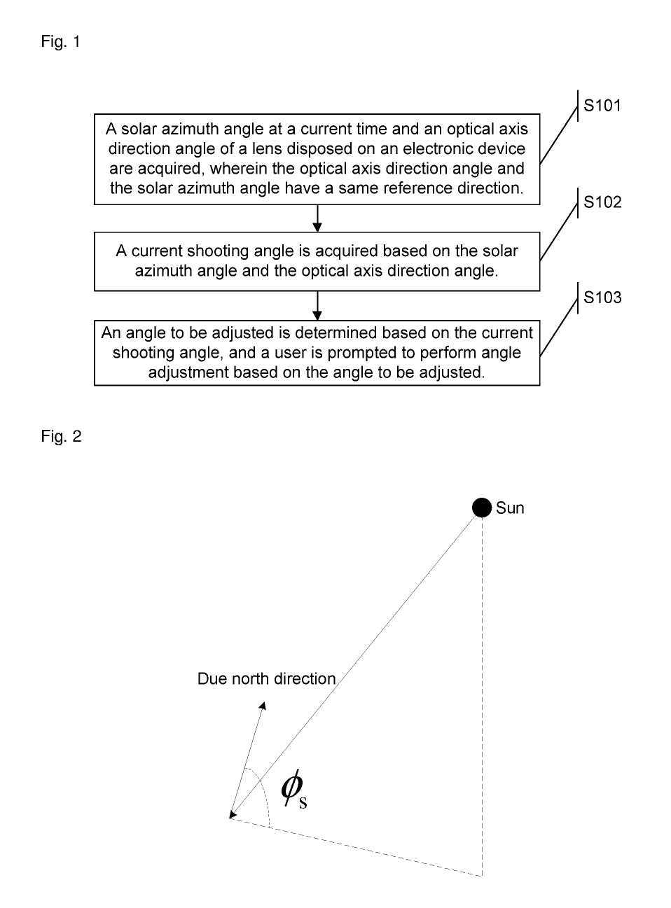

FIG. 1 is a flow chart of a user prompting method according to an embodiment of the present disclosure. As shown in FIG. 1, the method includes that:

S101: a solar azimuth angle at a current time and an optical axis direction angle of a lens disposed on an electronic device are acquired, wherein the optical axis direction angle and the solar azimuth angle have a same reference direction.

Specifically, in a first step, the electronic device acquires a latitude D of a current position of its own, and acquires a current date and time t at the same time.

In a practical application, the electronic device may acquire the latitude of the current position through the GPS module, and acquire the current date and time through a clock module; of course, it may also acquire the current date and time through the GPS module by using satellite synchronization time. The present disclosure is not particularly limited. In a second step, the electronic device calculates a solar declination angle and a solar elevation angle at the current time.

In a practical application, the electronic device may first calculate a hour angle h of the current time t by formula (1).

h=(t−12)×15° (1)

where the hour angle h is 0° at noon; it is negative in the forenoon, namely, between 0:00 and 12:00; it is positive in the afternoon, namely, between 12:00 and 24:00.

Then, the hour angle h is brought into formula (2) to calculate the solar declination angle δ.

$$δ = - 23.45 ° \times cos [ \frac{360 °}{365} \times ( N + 10 ) ] \qquad ( 2 )$$

where N is a day number of the current date in a year, for example, the day number N of January 1 is 1, and the day number N of December 31 is 365.

Then, the latitude Φ, the hour angle h and the solar declination angle δ are brought into formula (3) to calculate the solar elevation angle δ; here, the solar elevation angle refers to an included angle between an incident direction of sunlight and a horizontal plane.

θₛ=arccos(cos h cos δ cos Φ+sin δ sin Φ) (3)

In a third step, the electronic device acquires the solar azimuth angle at the current time based on the latitude, the solar declination angle and the solar elevation angle.

Specifically, the electronic device calculates the solar azimuth angle φₛ by using following formula (4), wherein the solar azimuth angle is an angle measured in a clockwise direction in which a due north direction of a shooting subject is an initial direction and the incident direction of the sunlight is an ending direction. As shown in FIG. 2, at this time, the reference direction is the due north direction of the position where the shooting subject is located.

$${φ}_{s} = arccos ( \frac{sin δ - sin {θ}_{s} sin Φ}{cos {θ}_{s } cos Φ} ) \qquad ( 4 )$$

While acquiring the solar azimuth angle by above steps, the electronic device also acquires an orientation of the lens of the image capturing device via devices such as a gyroscope, an electronic compass and the like, and determines an included angle between the orientation and the above reference direction, namely, the due north of the position where the shooting subject is located, as the optical axis direction angle.

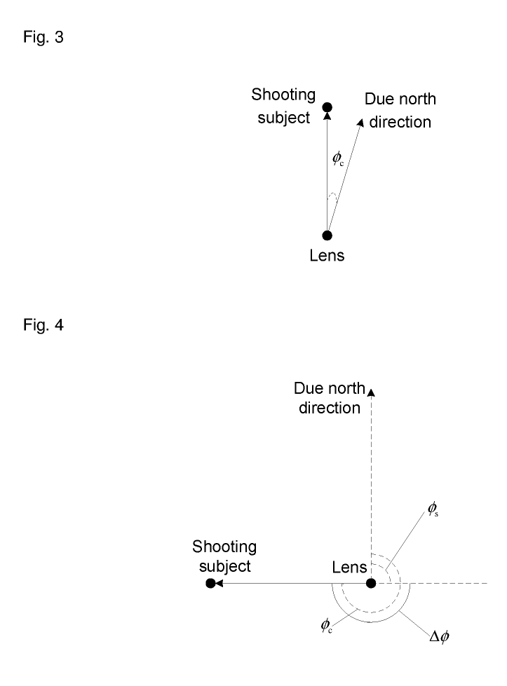

In a practical application, since the lens always faces the shooting subject, the optical axis orientation angle is a clockwise included angle between a vector of the lens pointing at the shooting subject and the reference direction. In the embodiment, the optical axis direction angle is denoted as φ_{c}, as shown in FIG. 3.

S102: a current shooting angle is acquired based on the solar azimuth angle and the optical axis direction angle.

Specifically, since the solar azimuth angle and the optical axis direction angle have the same reference direction, a difference between the solar azimuth angle and the optical axis direction angle is the current shooting angle, that is, an included angle between the incident direction of the sunlight and a back surface of the shooting subject.

For example, as shown in FIG. 4, the solar azimuth angle is φₛ=90°, the optical axis direction angle is φ_{c}=270°, and the current shooting angle is Δφ=|φₛ−φ_{c}|=180°.

S103: an angle to be adjusted is determined based on the current shooting angle, and a user is prompted to perform angle adjustment based on the angle to be adjusted.

Specifically, the electronic device determines a corresponding angle preset threshold according to the current shooting angle when it is determined that the current shooting angle satisfies a preset condition, and then determines a difference between the current shooting angle and the preset threshold as the angle to be adjusted. Finally, the electronic device prompts the user to adjust according to the angle to be adjusted.

In the embodiment, three shooting angle ranges are defined: [0°, 20° ] and [340°, 360° ] are defined as backlight angle ranges; [160°, 200° ] is defined as a direct light angle range; (20°, 160°) and (200°, 340°) are defined as subdued light angle ranges.

Then, the above preset condition may be at least one of: the current shooting angle is within the backlight angle range, the current shooting angle is within the direct light angle range, or the current shooting angle is within the subdued light angle range. The present disclosure is not particularly limited.

For example, at the current shooting angle Δφ×|φₛ−φ_{c}|=180°, the electronic device determines that the current shooting angle is within the direct light angle range, satisfying the preset conditions, and next, the electronic device determines an angle preset threshold corresponding to the direct light angle range, that is, two boundary values within the direct light angle range, namely, 160° and 200°. Then the electronic device makes a difference between Δφ and the two angle preset thresholds to acquire two angles to be adjusted, both of which are 20°. Finally, the electronic device generates an angle adjustment display screen, which prompts users to move the shooting subject to the left or right by 20°, or move left or right voluntarily by 20°. After the adjustment, the shooting angle is within the subdued light angle range, and the pictures taken at this time have a better effect.

In another embodiment, since the shooting subject of users may be a person or an object, in order to distinguish between different types of shooting subjects, before the step of determining a corresponding preset threshold when the current shooting angle satisfies the preset condition, the method further includes that: a type of the shooting subject is determined, and the preset condition is determined according to the type. That is, the electronic device needs to determine the corresponding preset condition according to the type of the shooting subject before determining the corresponding preset threshold.

In the specific implementation process, the electronic device acquires a cached image of the current shooting angle through the image capturing device, and performs the processing such as the face recognition and the object recognition to the image to determine the type of the shooting subject. For example, if the electronic device recognizes at least one face after performing the face recognition to the cached image, the electronic device determines that the shooting subject is a person; or, after performing the face recognition to the cached image, the electronic device recognizes that there is no person in the shooting subject. It is preferable that the electronic device judges whether or not a value of the solar elevation angle θₛ acquired in the above step is close to 0°, and if yes, the electronic device determines that the shooting subject is sun at sunrise or sunset. Of course, there are other ways of determining the type of the shooting subject, and the present disclosure is not particularly limited.

When the type of the shooting subject is a person, the corresponding preset condition may be such that the current shooting angle is within the backlight angle range or the current shooting angle is within the direct light angle range; and when the type of the shooting subject is sun at sunrise or sunset, the corresponding preset condition may be such that the current shooting angle is within the direct light angle range or the subdued light angle range.

Of course, for different types of shooting subjects, the corresponding preset condition may also have other conditions, and the actual application shall prevail. The present disclosure is not particularly limited.

Then, after determining the preset condition, the electronic device determines the corresponding angle preset threshold according to the current shooting angle after determining that the current shooting angle satisfies the preset condition, and then determines the difference between the current shooting angle and the preset threshold as the angle to be adjusted. Finally, the electronic device prompts the user to adjust based on the angle to be adjusted.

The user prompting method described in the above one or more embodiments will be described below with specific examples.

Assuming that the current time is at 11 am on June 21 in summer solstice in 2014, the user takes pictures of people in Shanghai with the backlight scene as the shooting scene.

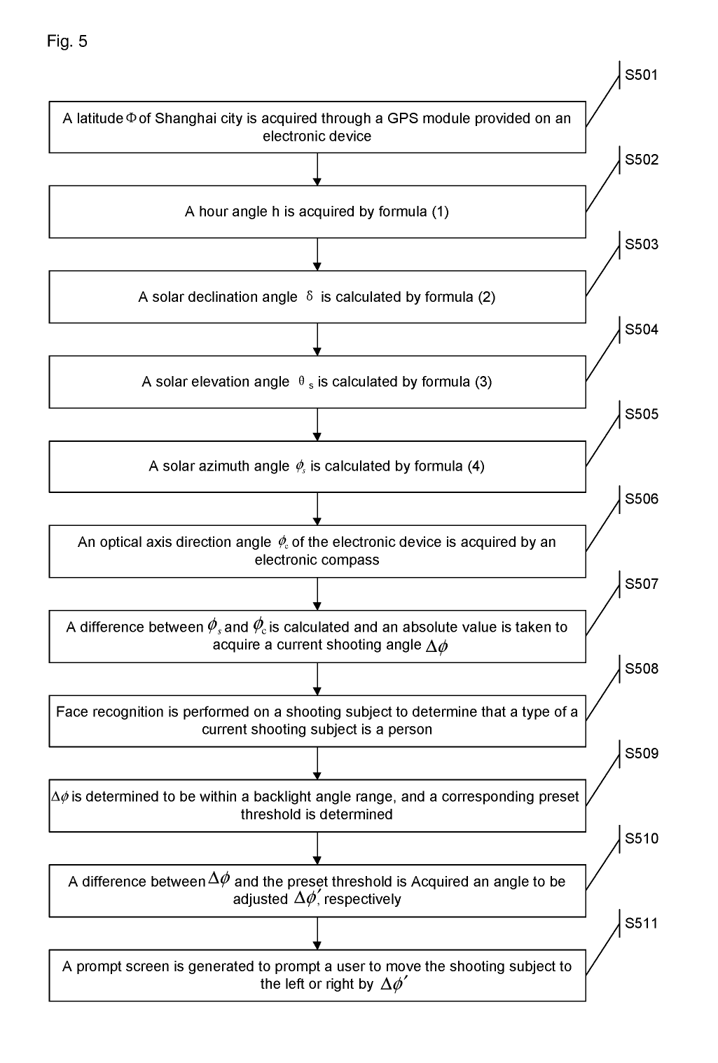

FIG. 5 is a flow chart of a user prompting method in a backlight scenario according to an embodiment of the present disclosure. As shown in FIG. 5, the method includes that:

S501: a latitude Φ of Shanghai city is acquired through a GPS module provided on an electronic device, namely, Φ=31.22°;

S502: a hour angle his acquired by formula (1), namely, h=(11−12)×15°=−15°;

S503: a solar declination angle δ is calculated by formula (2), namely, δ=23.45′;

S504: a solar elevation angle θₛ is calculated by formula (3), namely, θₛ=74.6°;

S505: a solar azimuth angle φₛ is calculated by formula (4), namely, φₛ=116.6°;

S506: an optical axis direction angle φ_{c} of the electronic device is acquired by an electronic compass, namely, φ_{c}=126.6°;

S507: a difference between φₛ and φ_{c} is calculated and an absolute value is taken to acquire a current shooting angle, namely, Δφ=10°;

S508: face recognition is performed on a shooting subject to determine that a type of a current shooting subject is a person;

S509: Δφ is determined to be within a backlight angle range, and a corresponding preset threshold is determined, namely, 340° or 20°;

S510: a difference between Δφ and the preset threshold is acquired an angle to be adjusted Δφ′, respectively; namely, Δφ=10° and Δφ′=−330°; and

S511: a prompt screen is generated to prompt a user to move the shooting subject to the left or right by Δφ′; that is, the user is prompted to move to the left by 10° or to the right by 40°.

Preferably, the current shooting angle is also displayed in real time on the prompt screen to prompt the user of the rest degree to be rotated.

As described above, the electronic device can automatically acquire the current shooting angle and determine the angle to be adjusted, so the user can get a better shooting effect only by adjusting to the angle to be adjusted according to the prompt, without having to try again and again. In such way, the technical problem in the related art that shooting efficiency is low is effectively solved, the shooting efficiency is improved, it is convenient for users to operate, and user experience is improved.

An embodiment of the present disclosure also provides a computer storage medium, in which a computer-executable instruction may be stored, the computer-executable instruction being configured to execute the abovementioned user prompting method.

Based on the same inventive concept, an embodiment of the present disclosure provides an electronic device, wherein the electronic device is consistent with the electronic device in the one or more embodiments described above.

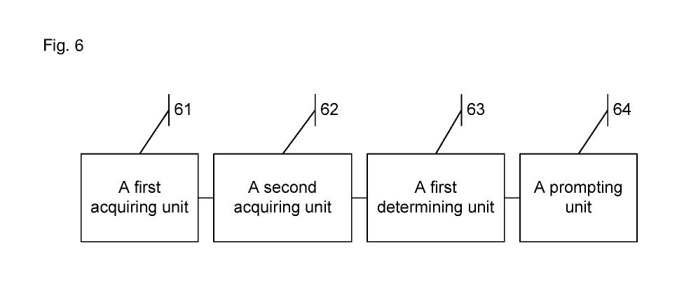

FIG. 6 is a structure schematic diagram of an electronic device according to an embodiment of the present disclosure. As shown in FIG. 6, the electronic device includes: a first acquiring unit 61 configured to acquire a solar azimuth angle at a current time and an optical axis direction angle of a lens disposed on the electronic device, wherein the optical axis direction angle and the solar azimuth angle have a same reference direction; a second acquiring unit 62 configured to acquire a current shooting angle based on the solar azimuth angle and the optical axis direction angle; a first determining unit 63 configured to determine an angle to be adjusted based on the current shooting angle; and a prompting unit 64 configured to prompt a user to perform angle adjustment based on the angle to be adjusted.

Preferably, the first acquiring unit 61 is configured to acquire a latitude of a position where the electronic device is located currently, a solar declination angle at the current time and a solar elevation angle at the current time; and acquire the solar azimuth angle based on the latitude, the solar declination angle, and the solar elevation angle.

Preferably, the first acquiring unit 61 is configured to acquire an orientation of the lens; and determine an included angle between the orientation and the reference direction as the optical axis direction angle.

Preferably, the first determining unit 63 is configured to determine a corresponding preset threshold when the current shooting angle satisfies a preset condition; and determine a difference between the current shooting angle and the preset threshold as the angle to be adjusted.

Preferably, the electronic device further includes: a second determining unit configured to, before determining a corresponding preset threshold when the second acquiring unit 62 determines that the current shooting angle satisfies a preset condition, determine a type of the shooting subject, and determine the preset condition according to the type.

In a practical application, each of the first acquiring unit 61, the second acquiring unit 62, the first determining unit 63, the prompting unit 64, and the second determining unit may be implemented by a Central Processing Unit (CPU), an Advanced Reduced Instruction Set Machines (ARM), a Digital Signal Processor (DSP), a Micro Processor Unit (MPU), or a Field Programmable Gate Array (FPGA), and the like in the electronic device, and the present disclosure is not particularly limited.

Those skilled in the art should know that the embodiment of the present disclosure may be provided as a method, a system or a computer program product. Therefore, the present disclosure may adopt a form of hardware embodiment, software embodiment and combined software and hardware embodiment. Moreover, the present disclosure may adopt a form of computer program product implemented on one or more computer-available storage media (including, but not limited to, a disk memory and an optical memory) including computer-available program codes.

The present disclosure is described with reference to flowcharts and/or block diagrams of the method, equipment (system) and computer program product according to the embodiment of the present disclosure. It should be understood that each flow and/or block in the flowcharts and/or the block diagrams and combinations of the flows and/or blocks in the flowcharts and/or the block diagrams may be implemented by computer program instructions. These computer program instructions may be provided for a universal computer, a dedicated computer, an embedded processor or a processor of other programmable data processing equipment to generate a machine, so that a device for realizing a function specified in one flow or more flows in the flowcharts and/or one block or more blocks in the block diagrams is generated by the instructions executed through the computer or the processor of the other programmable data processing equipment.

These computer program instructions may also be stored in a computer-readable memory capable of guiding the computer or the other programmable data processing equipment to work in a specific manner, so that a product including an instruction device may be generated by the instructions stored in the computer-readable memory, the instruction device realizing the function specified in one flow or many flows in the flowcharts and/or one block or many blocks in the block diagrams.

These computer program instructions may further be loaded onto the computer or the other programmable data processing equipment, so that a series of operating steps are executed on the computer or the other programmable data processing equipment to generate processing implemented by the computer, and steps for realizing the function specified in one flow or many flows in the flowcharts and/or one block or many blocks in the block diagrams are provided by the instructions executed on the computer or the other programmable data processing equipment.

The above are only preferred embodiments of the present disclosure and not intended to limit the scope of patent of the present disclosure.

### INDUSTRIAL APPLICABILITY

Embodiments of the present disclosure provide a user prompting method, an electronic device, and a computer storage medium. The method includes that: a solar azimuth angle at s current time and an optical axis direction angle of a lens disposed on the electronic device are acquired, wherein the optical axis direction angle and the solar azimuth angle have a same reference direction; a current shooting angle is acquired based on the solar azimuth angle and the optical axis direction angle; and an angle to be adjusted is determined based on the current shooting angle, and a user is prompted to adjust to the angle to be adjusted. In other words, the user can get a better shooting effect only by adjusting to the angle to be adjusted according to the prompt, without having to try again and again. In such way, the technical problem in the related art that shooting efficiency is low is effectively solved, the shooting efficiency is improved, it is convenient for users to operate, and user experience is improved.

1. A user prompting method, applied to an electronic device, comprising:
acquiring a solar azimuth angle at a current time and an optical axis direction angle of a lens disposed on the electronic device, wherein the optical axis direction angle and the solar azimuth angle have a same reference direction;
acquiring a current shooting angle based on the solar azimuth angle and the optical axis direction angle; and
determining an angle to be adjusted based on the current shooting angle, and prompting a user to perform angle adjustment based on the angle to be adjusted.

2. The method according to claim 1, wherein the step of acquiring a solar azimuth angle at a current time comprises:
acquiring a latitude of a position where the electronic device is located currently, a solar declination angle at the current time and a solar elevation angle at the current time; and
acquiring the solar azimuth angle based on the latitude, the solar declination angle, and the solar elevation angle.

3. The method according to claim 1, wherein the step of acquiring an optical axis direction angle of a lens disposed on the electronic device comprises:
acquiring an orientation of the lens; and
determining an included angle between the orientation and the reference direction as the optical axis direction angle.

4. The method according to claim 1, wherein the step of determining an angle to be adjusted based on the current shooting angle comprises:
determining a corresponding preset threshold when the current shooting angle satisfies a preset condition; and
determining a difference between the current shooting angle and the preset threshold as the angle to be adjusted.

5. The method according to claim 4, further comprising: before determining a corresponding preset threshold when the current shooting angle satisfies a preset condition,
determining a type of a shooting subject, and determining the preset condition according to the type.

6. An electronic device, comprising:
a processor; and
a memory for storing instructions executable by the processor;
wherein the processor is configured to:
acquire a solar azimuth angle at a current time and an optical axis direction angle of a lens disposed on the electronic device, wherein the optical axis direction angle and the solar azimuth angle have a same reference direction;
acquire a current shooting angle based on the solar azimuth angle and the optical axis direction angle;
determine an angle to be adjusted based on the current shooting angle; and
prompt a user to perform angle adjustment based on the angle to be adjusted.

7. The electronic device according to claim 6, wherein the processor is further configured to:
acquire a latitude of a position where the electronic device is located currently, a solar declination angle at the current time and a solar elevation angle at the current time; and acquire the solar azimuth angle based on the latitude, the solar declination angle, and the solar elevation angle.

8. The electronic device according to claim 6, wherein the processor is further configured to:
acquire an orientation of the lens; and determine an included angle between the orientation and the reference direction as the optical axis direction angle.

9. The electronic device according to claim 6, wherein the processor is further configured to:
determine a corresponding preset threshold when the current shooting angle satisfies a preset condition; and determine a difference between the current shooting angle and the preset threshold as the angle to be adjusted.

10. The electronic device according to claim 9, wherein the processor is further configured to: before determining a corresponding preset threshold when it is determined that the current shooting angle satisfies a preset condition, determine a type of a shooting subject, and determine the preset condition according to the type.

11. A non-transitory computer-readable storage medium, in which a computer-executable instruction is stored, the computer-executable instruction being configured to execute a user prompting method which is applied to an electronic device, comprising:
acquiring a solar azimuth angle at a current time and an optical axis direction angle of a lens disposed on the electronic device, wherein the optical axis direction angle and the solar azimuth angle have a same reference direction;
acquiring a current shooting angle based on the solar azimuth angle and the optical axis direction angle; and
determining an angle to be adjusted based on the current shooting angle, and prompting a user to perform angle adjustment based on the angle to be adjusted.

12. The non-transitory computer-readable storage medium according to claim 11, wherein the step of acquiring a solar azimuth angle at a current time comprises:
acquiring a latitude of a position where the electronic device is located currently, a solar declination angle at the current time and a solar elevation angle at the current time; and
acquiring the solar azimuth angle based on the latitude, the solar declination angle, and the solar elevation angle.

13. The non-transitory computer-readable storage medium according to claim 11, wherein the step of acquiring an optical axis direction angle of a lens disposed on the electronic device comprises:
acquiring an orientation of the lens; and
determining an included angle between the orientation and the reference direction as the optical axis direction angle.

14. The non-transitory computer-readable storage medium according to claim 11, wherein the step of determining an angle to be adjusted based on the current shooting angle comprises:
determining a corresponding preset threshold when the current shooting angle satisfies a preset condition; and
determining a difference between the current shooting angle and the preset threshold as the angle to be adjusted.

15. The non-transitory computer-readable storage medium according to claim 14, the method further comprising: before determining a corresponding preset threshold when the current shooting angle satisfies a preset condition,
determining a type of a shooting subject, and determining the preset condition according to the type.
